(19) United States
(12) Patent Application Publication
(10) Pub. No.: US 2014/0149470 A1
(43) Pub. Date: May 29, 2014

(54) SYSTEMS AND METHODS FOR STORING AND POPULATING FORMS

(71) Applicant: SANDEEP RAWAL, (US)

(72) Inventor: SANDEEP RAWAL, (US)

(21) Appl. No.: 13/686,686

(22) Filed: Nov. 27, 2012

(51) Int. Cl. G06F 17/30

(52) U.S. Cl. CPC G06F 17/30312
USPC 707/812

(57) ABSTRACT

Systems and methods relating to forms are provided. The form systems and methods may store and complete forms of any types from different form sources. According to some embodiments, the method completes a form by receiving data from different sources, allocating and assigning data attributes to the data, and determining a value for each field in the form. The method determines and stores an algorithm for determining a value for a field. The method determines a value for a field according to a user's defined algorithm. The method may further generate an output form that is visually the same as the original form with fields completed following the instructions in the original form.

### TECHNICAL FIELD

The present invention(s) generally relate to computer systems, and more particularly, some embodiments relate to forms and computer implemented methods for populating or completing forms.

### DESCRIPTION OF THE RELATED ART

Often, organizations are required to complete various types of forms regularly to comply with federal and state laws, regulations, and other requirements. For example, finance forms are often used to report financial events. A financial event may be any activity that involves a financial transaction or that has a financial impact. Examples include earing wages, trading stocks, bonds, hedge funds, commodities, and currencies, receiving mortgage payments, and paying business expenses. These forms may vary in length, and may include multiple sections. In many cases, population of forms may be time-consuming and prone to errors. Because many field values in a form are determined or calculated from information from many different sources, the chances of entering an incorrect value can be significant. Additionally, forms are often updated with new instructions, which adds to the complexity of completing such forms.

### BRIEF SUMMARY OF EMBODIMENTS OF THE INVENTION(S)

According to various embodiments, systems and methods for computer assisted form population are provided. The form systems and methods may store and assist in completing forms of various types (e.g., financial, business, government, application, and general disclosure) from different form sources, such as the U.S. Security and Exchange Commission (SEC), the Internal Revenue Service (IRS), and state-based taxing agencies. Various embodiments may be provided to assist a user in populating a form by collecting data from various data sources, allocating and assigning attributes associated with a form to the data received, and determining value(s) for a field. In one embodiment, the systems and methods can be configured to store and execute one or more algorithms used to calculate a value for one or more fields in the form. In a further embodiment, the systems and methods can be configured to determine values for one or more fields according to one or more user-defined algorithms or algorithms determined based on form instructions useful for or required to populate the one or more fields. Various embodiments may also be configured to generate an output form that is visually the same as or similar to the original form with various fields completed in accordance with the instructions of the form. Further embodiments may be configured to enable approval or un-approval of a value for a data field, ignoring or un-ignoring a data field, or creating a note in association with a data field, or modifying a value for a data field.

An exemplary method for storing and validating forms may include receiving, at a computer system, a form comprising a hierarchy of sections, wherein a section of the hierarchy of sections comprises a set of data elements, and a data element of the set of data elements comprises a data element value and data element metadata. The method may store a first data table entry in a first data table such that the first data table entry corresponds to the data element, and the first data table entry comprises a section identification (ID) identifying the section and associates the data element with the section. Further, the method may store a second data table entry in a second data table such that the second data table entry corresponds to the data element, and the second data table entry comprises the data element metadata and a link to the first data table entry.

Other features and aspects of the systems and methods described herein will become apparent from the following detailed description, taken in conjunction with the accompanying drawings, which illustrate, by way of example, the features in accordance with embodiments of the systems and methods described herein. The summary is not intended to limit the scope of the systems and methods described herein, which is defined solely by the claims attached hereto.

### BRIEF DESCRIPTION OF THE DRAWINGS

The present invention(s), in accordance with one or more various embodiments, are described in detail with reference to the following figures. The drawings are provided for purposes of illustration only and merely depict typical or example embodiments of the systems and methods described herein. These drawings are provided to facilitate the reader's understanding of the systems and methods and shall not be considered limiting of the breadth, scope, or applicability of the systems and methods. It should be noted that for clarity and ease of illustration these drawings are not necessarily made to scale.

FIG. 1 illustrates a simplified environment in which an exemplary form storage and validation system operates in accordance with an embodiment of the systems and methods described herein.

FIG. 2 illustrates an exemplary hierarchy of a form that can be processed in accordance with an embodiment of the systems and methods described herein.

FIGS. 3-5 illustrate an exemplary method of storing a form in accordance with an embodiment of the systems and methods described herein.

FIGS. 6-7 illustrate an exemplary method of completing a form in accordance with an embodiment of the systems and methods described herein.

FIG. 8 is a flowchart illustrating an exemplary method of creating an output form in accordance with an embodiment of the systems and methods described herein.

FIG. 9 is a flowchart illustrating an exemplary method of preparing a form in accordance with an embodiment of the systems and methods described herein.

FIG. 10 is a diagram illustrating an example computing module that may be used in implementing various features of embodiments of the systems and methods described herein.

The figures are not intended to be exhaustive or to limit the systems and methods described herein to the precise form disclosed. It should be understood that the systems and methods can be practiced with modification and alteration, and that the systems and methods be limited only by the claims and the equivalents thereof.

### DETAILED DESCRIPTION OF THE EMBODIMENTS OF THE INVENTION(S)

Various embodiments provide for systems and methods relating to storage and population of forms, such as, for example, forms relating to finance, business, and government. The systems and methods described herein may include structures that are extendable over time and are capable of storing and assisting in the population of various forms from different form sources. Multiple data tables may be used together to describe and define a form, and these data tables may be linked to one another. For example, a first data table entry may associate a data element, which corresponds to a field in the form, with a corresponding section. A second data tale entry may store the data element with the data element value, the data element metadata, or a link to the first table. One or more additional data tables may be created or the second table may be further configured, to store user defined algorithms for calculating data element values, to audit a form, to monitor a workflow, to archive forms, or to track changes of a form.

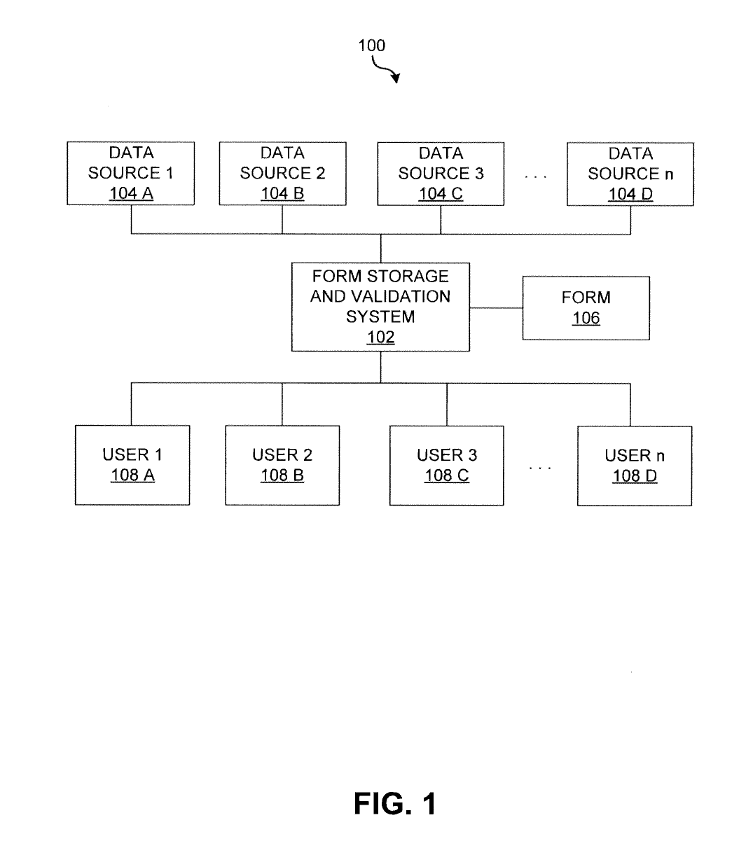

Before describing the invention(s) in detail, it may be useful to describe an example environment with which some embodiments can be used. FIG. 1 is a diagram illustrating a simplified environment 100 in which an exemplary form storage and validation system 102 operates in accordance with an embodiment of the systems and methods described herein. In this example environment, the form storage and validation system 102 is coupled to at least one data source from data sources 104A through D, and at least one user from users 108A through D. A user may be a human, a module, a computer, computer program, or some other entity. The form storage and validation system 102 may be configured to receive a form 106. The form 106 may be of any file format (e.g., Portable Document Format (PDF) or an Excel® spreadsheet), and may comprise a set of fields, which may or may not be completed when received. The form 106 may also comprise labels and descriptions for various fields, and instructions on how to complete the form.

The form storage and validation system 102 may be configured to process, store, complete, and validate the form 106. In some embodiments, the form storage and validation system 102 may receive and process data files from a data source 102. Data files received may comprise data necessary or useful for populating the form. The form storage and validation system 102 may assign attributes associated with a form to the data received, store the data and use the data to populate the form 106 accordingly. Further, a user 108 may access, complete, modify, validate, and submit a form 106 through the form storage and validation system 102 manually. Via a User Interface (UI) of the form storage and validation system 102, a user 108 may also approve or deny a data element value for a data field, ignore or flag a data field, make a note in association with a data field, and/or modify a data element value for a data field through the form storage and validation system 102.

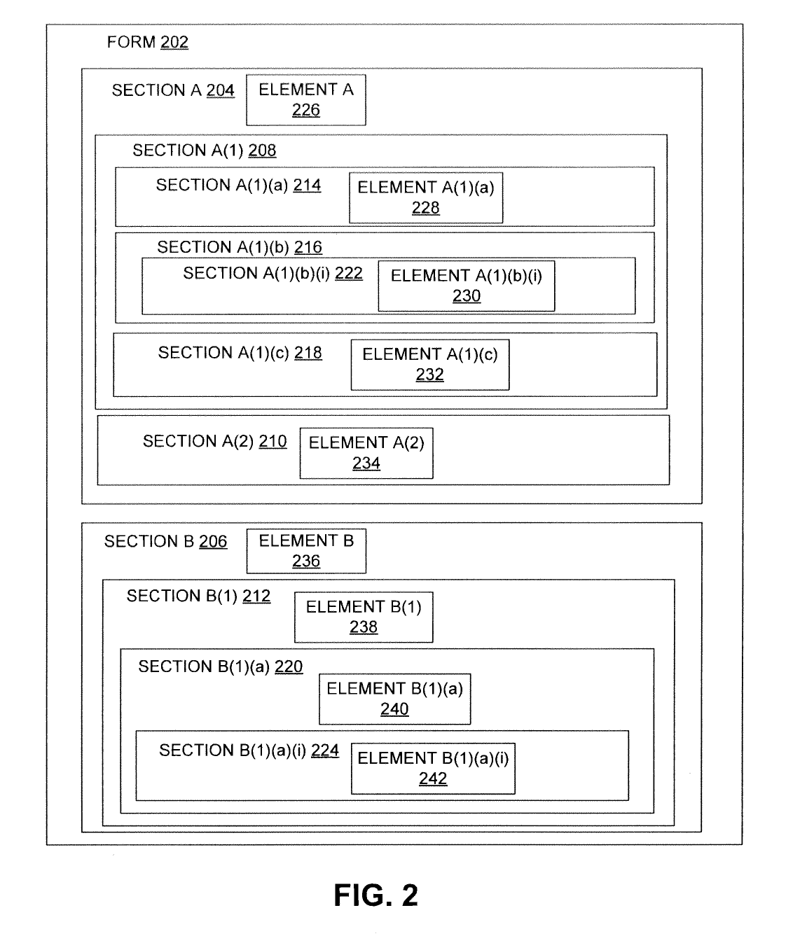

FIG. 2 illustrates a form 202 that an exemplary form storage and validation system 102 may process in accordance with an embodiment of the systems and methods described herein. In the illustrated example, the form 202 comprises multiple sections and data elements, which may be related. As shown, form 202 comprises two sections: Section A 204 and Section B 206, with section A 204 comprising section A(1) 208 and section A(2) 210 as subsections, and section B 206 comprising section B(1) 212 as a subsection. The remainder of the hierarchy is shown as follows: section A(1) 208 comprises section A(1)(a) 214, section A(1)(b) 216, and section A(1)(c) 218 as subsections; section A(1)(b) 216 comprises section A(1)(b)(i) 222 as a subsection; section B(1) 212 comprises section B(1)(a) 220 as a subsection; and section B(1)(a) 220 comprises section B(1)(a)(i) 224 as a subsection.

With respect to data elements, section A comprises data element A 226, section A(1)(a) comprises data element A(1)(a) 228, section A(1)(b)(i) comprises data element A(1)(b)(i) 230, section A(1)(c) comprises data element A(1)(c) 232, section A(2) comprises data element A(2) 234, section B comprises data element B 236, section B(1) comprises data element B(1) 238, section B(1)(a) comprises data element B(1)(a) 240, and section B(1)(a)(i) comprises data element B(1)(a)(i) 242. For some embodiments, a data element may comprise a request by the form (e.g., a fillable field of the form) for information from the user completing the form. One of ordinary skill in the art will understand that sections of a form may also be known or described by other terms, including for example sectors, parts, sets, groups, classes, or divisions.

From time-to-time, the systems and methods described herein are described herein in terms of this example environment illustrated by FIGS. 1 and 2. Description in terms of these environments is provided to allow the various features and embodiments of the systems and methods described herein to be portrayed in the context of an exemplary application. After reading this description, it will become apparent to one of ordinary skill in the art how the systems and methods described herein can be implemented in different and alternative environments.

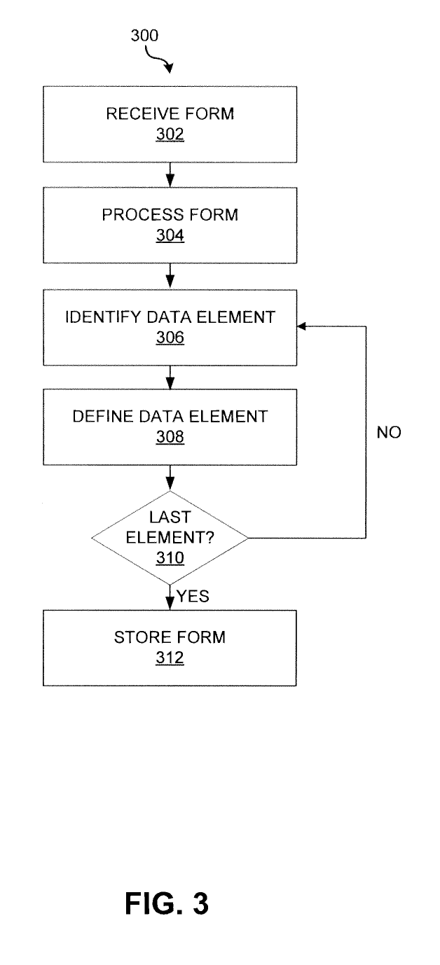

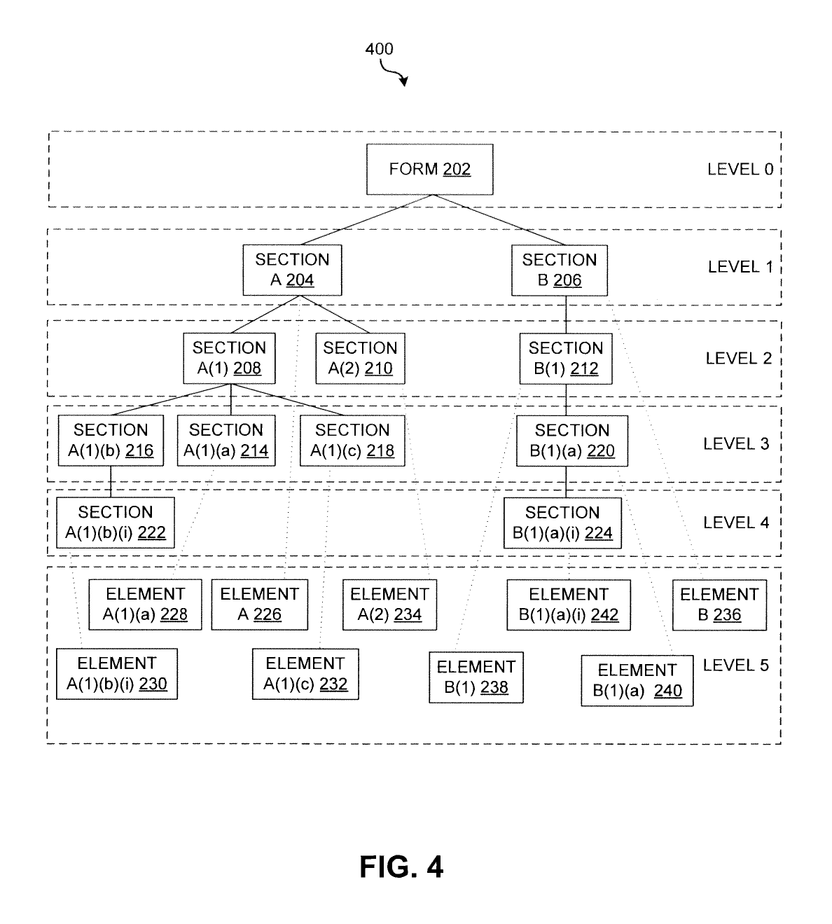

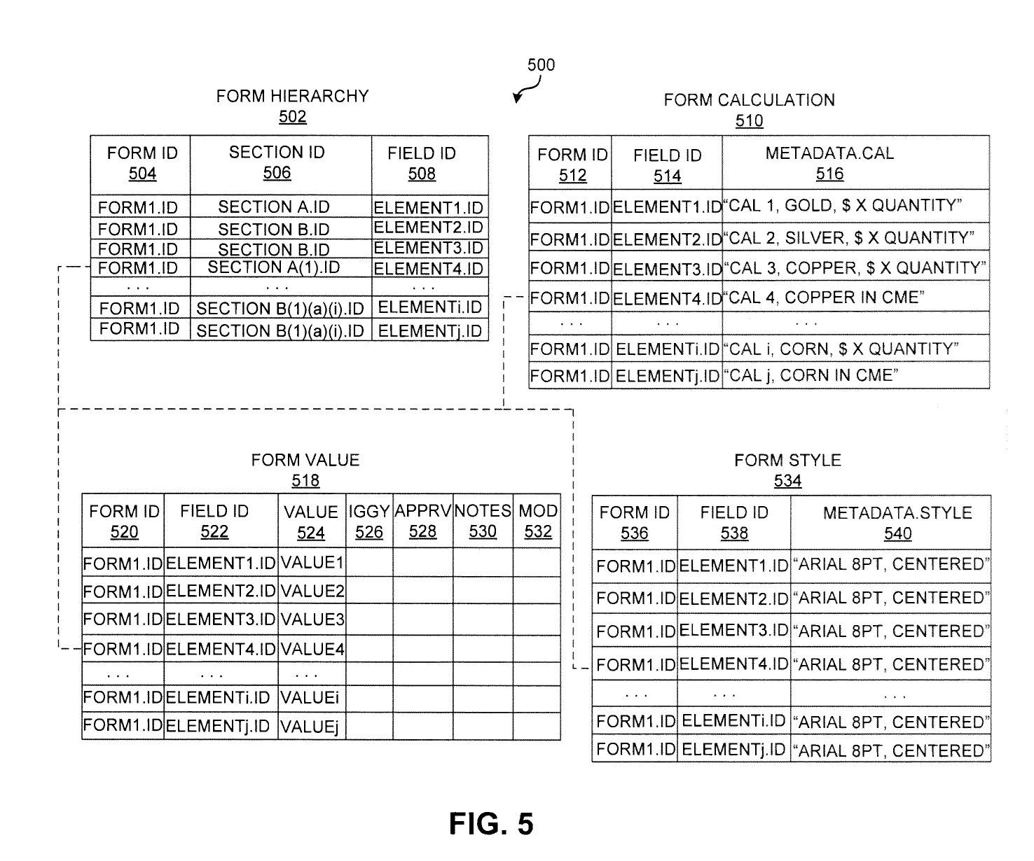

FIGS. 3-5 illustrate an exemplary process 300 for storing a form in accordance with an embodiment of the systems and methods described herein. FIG. 3 is a flow chart illustrating an exemplary process 300 for storing a form in accordance with an embodiment of the systems and methods described herein. FIG. 4 illustrates an exemplary structure of a form that an exemplary method of storing a form follows. FIG. 5 illustrates exemplary data tables that an exemplary method of storing a form uses. The following describes the process 300 of FIG. 3 and references FIGS. 4 and 5 for illustrative purposes.

At operation 302, method 300 receives a form from a form source. Form sources can include, for example, the SEC, the IRS, or a user who needs to complete a form. The form may be received as a file having one of many file formats including, for example, extensible mark-up language (XML) or Portable Document Format (PDF). As one particular example, the form may be the Form PF issued by the SEC in a PDF format. Generally, the file received provides the content and structure of a given form, from which the section(s) and data element(s) of the form can be determined.

At operation 304, the method 300 processes the form. In one embodiment, the method 300 processes the form by processing all the data elements comprised therein. The method may identify and describe the composition of the form, including all the data elements and sections of the form and the relationship among the data elements and the sections. For example, subsequent to receiving the form 202, the method 300 may determine that the form 202 (e.g., as illustrated in FIG. 2) includes sections: section A 204 and Section B 206. The method may further determine that: section A 204 comprises sections A(1)-A(2) as subsections, section A(1) comprises section A(1)(a)-A(1)(c) as subsections and section A(1)(b) comprises section A(1)(b)(i) as a subsection; section B 206 comprises section B(1) as a subsection which comprises section B(1)(a) as a subsection further comprising section B(1)(a)(i) as a subsection. The method may further determine that sections A, A(1)(a), A(1)(b)(i), A(1)(c), A(2), B, B(1), B(1)(a), and B(1)(a)(i) each comprises its respective data element. Each data element, such as a fillable field of the form, is a request by the form for information from the user who completes the form.

Continuing with reference to FIG. 3, at operation 306, the method identifies a data element out of all the data elements in the form. For example, with respect to the form 202, the method 300 may identify a data element out of all the data elements that are included in the form 202. Subsequently, at operation 308, the method 300 may generate data element metadata for the data element such that the data element metadata comprises relevant information pertaining to the data element. For instance, the method 300 may define the data element metadata with such information as the section to which the data element corresponds, the relationship between a section of the form 202 and another section of the form 202, and a description of the data element (e.g., labels, instructions.) In one embodiment, the method 300 may define the data element metadata with further information, such as an algorithm for calculating a data element value and a visual style (e.g., font type, font size, whether to bold or not, whether to underline or not, alignment, etc) for presenting the data element. In some embodiments, the method 300 may determine and define the calculation to include the algorithm according to the instructions in a form, and may further define the calculation to include a validation process for the data element value. In further embodiments, the method 300 may define a data element with information of the form, of the section, and of the data element. Exemplary information includes, for example, the release date, the revision, comments, and the expiration date.

As illustrated in FIG. 4, a hierarchical, tree-structure or other relationship can exist among various sections in the form 202. The method 300 may detect this relationship for the form 202 and determine that the form 202 comprises a total of five levels. Level 0, which is the top level, represents the form 202 itself. Level 1 represents sections A and B included in form 202. Level 2 represents subsections A(1), A(2), and B(1) included in sections A and B, respectively. Level 3 represents subsections A(1)(a)-(c) and B(1)(a) included in sections A(1) and B(1), respectively. Level 4 represents subsections A(1)(b)(i) and B(1)(a)(i) included in sections A(1)(b) and B(1)(a), respectively. The last level, level 5 represents all the data elements. The method 300 may process data elements by following the relationships between the sections. For example, the method 300 may process the data elements from the top of the tree-structure to the bottom of the tree-structure, where the method 300 begins at level 0 and traverses down toward level 5.

With continued reference to FIG. 3, at operation 310, the method 300 may check whether a data element is the last data element to be processed. Subsequently, at operation 312, the method 300 may store the form by storing all the data elements processed. In some embodiments, the method 300 may store a user's commands related to each data field, if there is any. Exemplary user's commands include, for example, ignoring or un-ignoring, approving or un-approving, and modifying any data field and creating notes in association with any data field. In one embodiment, a user may ignore a data field of a form and the method 300 may store the corresponding data element accordingly. For example, a user may mark a data field as ignored when the data field needs not be completed. In some embodiments, when the data field is marked as ignored, no further changes may be made to the corresponding data element for a predefined period (e.g., a form reporting period). Certain users (e.g., users with security rights) may clear the ignore mark (i.e., un-ignore) from data fields that have been marked as ignored.

In some embodiments, a user may approve a data element value for a data field of a form and the method 300 may store the corresponding data element accordingly. When a data element value for a data field is marked as approved, no further changes may be made to the corresponding data element for a given period (e.g., a form reporting period) as the user intends that the data filed should not be updated. Certain users (e.g., users with security rights) may clear the approval (e.g., un-approve) data fields that have been approved.

In further embodiments, a user may create notes for a data field. A note may be an internal note that can be used to track internal discussions. A note may also be an assumption for the data field. An assumption informs the party to whom the form may be submitted (e.g., filing authorities) on details of the process taken to calculate a data element value. For example, where the requirements for a data field are not clearly defined or ambiguous and subject to interpretation by a user filing out the form, the user may create an assumption. In various embodiments, a user may modify a data element value manually and the method 300 may store the value entered by the user accordingly. The method 300 may validate the value entered by the user, for example, a text value may not be entered in a numeric field, a value may not be entered if it is out of a required range.

FIG. 5 illustrates exemplary data tables 502, 510, 518, and 534 of a method of storing a form in accordance with an embodiment of the systems and methods described herein. In one embodiment, the method may store a form into two data tables that are based on a key-value pair structure. In some embodiments, the method may store a form into multiple data tables that are based on a key-value pair structure. In some embodiments, any form may be stored into two or more data tables and be reconstructed at any time. These two or more data tables together may define and describe a form, including its hierarchy and the attributes of its fields. For example, each data table entry of the first data table may associate a data element with a corresponding section of the form. The second or additional data tables may define each data element of the form including a calculation for determining the value of the data element, a description of the data element, and a visual style for the data element.

In the illustrated embodiment, data table 502 Form Hierarchy represents an example of a first table, data table 510 Form Calculation represents an example of a second table, data table 518 Form Value represents an example of a third table, and data table 526 Form Style represents an example of a fourth table. In accordance with various embodiments, data table 502 Form Hierarchy, data table 510 Form Calculation, data table 518 Form Value, and data table 534 Form Style together may define and describe a form. One skilled in the art should appreciate that data table 510 Form Calculation, data table 518 Form Value, and data table 534 Form Style may be combined into fewer data tables than shown (e.g., 1 table), which together with the first data table 502 Form Hierarchy may define a form. As shown, a row of the data table 502 Form Hierarchy corresponds to a data element of the form, which may be a field of the form. In the illustrated example, data table 502 Form Hierarchy comprises three columns: column 504 Form ID, column 506 Section ID, and column 508 Field ID. Each entry in the data table 502 Form Hierarchy may identify a data element and the section to which that data element corresponds. Each section may be identified by a section identification (ID). The first data table may comprise an ID that uniquely identifies a data element.

In the illustrated example, the second data table 510 Form Calculation, the third data table 518 Form Value, and the fourth data table 534 Form Style together define metadata for all the data elements. The second data table 510 Form Calculation defines calculations for all the data elements, the third data table 518 Form Value stores data element values as well as the user's commands, and the fourth data table 526 Form Style defines visual styles for all the data elements. As shown, the data tables 510, 518, and 526 describe a form for reporting commodity trading, where each row of the data tables 510, 518, and 526 corresponds to a data element, such as a fillable field of a form. For instance, the data element corresponding to “Element4.ID” of the data table 510 may comprise the worth of copper traded at the Chicago Mercantile Exchange (CME), while the metadata for the same data element may comprise the calculation for determining the value, the label, or the instruction as stored in the data table 510, the visual style of the data element (e.g., the font style and size as well as the alignment) as stored in the data table 534.

In further embodiments, metadata for each data element may include the relationship of the data element with other sections. To facilitate the relationship between data elements, data element values, and data element metadata, the data tables may be linked. For example, in the illustrated embodiment, each entry of the data table 502 Form Hierarchy is linked to an entry of the data table 510 Form Definition, an entry of the data table 518 Form Value, and an entry of the data table 534 Form Style by way of the Form ID and Field ID. In some embodiments, additional data tables may be created. Each row of an additional data table may correspond to a data element and may be linked to the first data table, the second data table or both. In further embodiments, a user may monitor a workflow relating to completing a form, and the workflow may be stored in one data table. In various embodiments, a user may track changes of a data form for auditing purposes and the changes in the forms are stored in one data table.

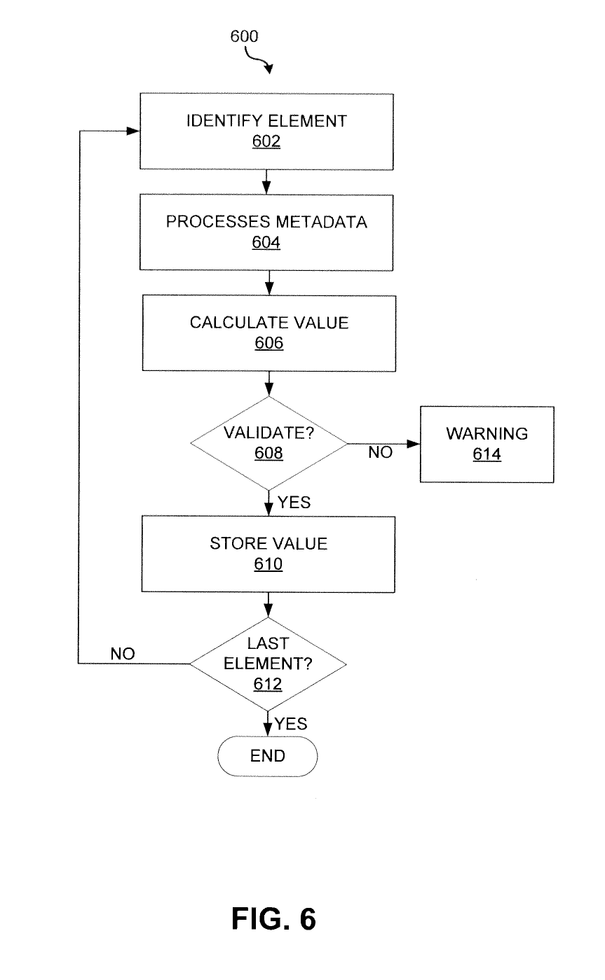

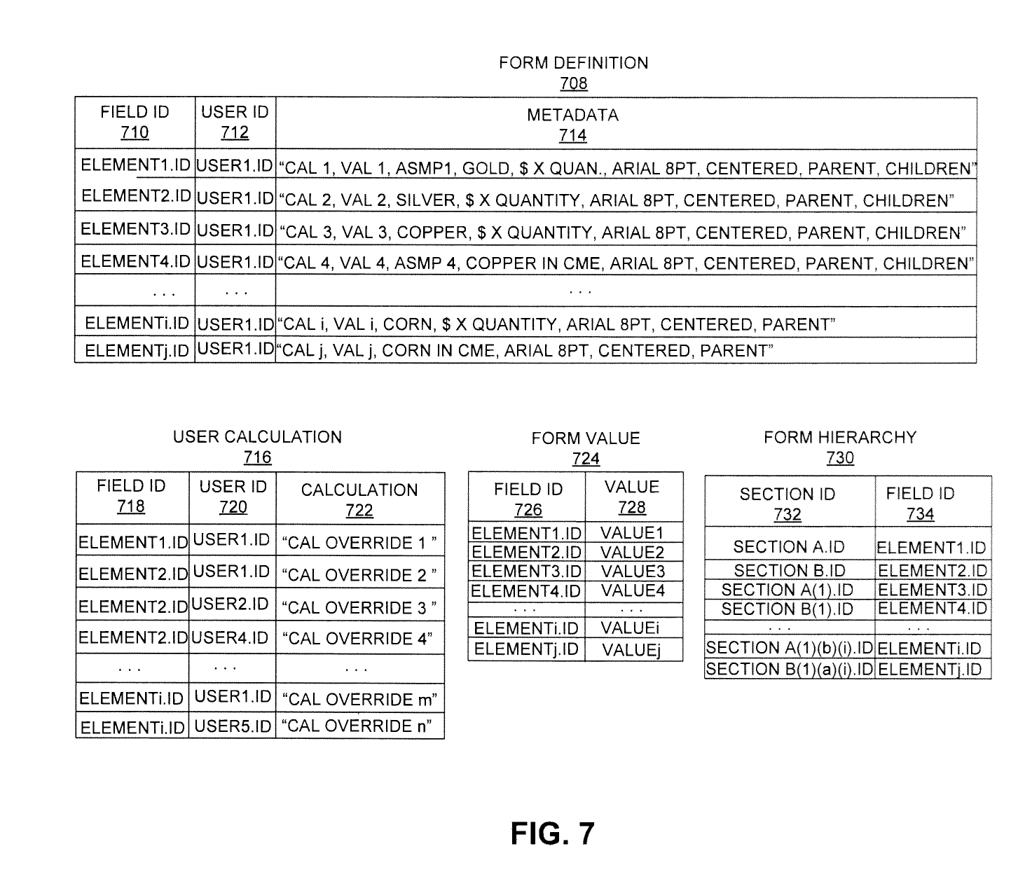

FIGS. 6-7 illustrate an exemplary method 600 of completing a form in accordance with an embodiment of the systems and methods described herein. FIG. 6 is a flow chart illustrating an exemplary process 600 for populating a form in accordance with one embodiment of the systems and methods described herein. FIG. 7 illustrates exemplary data tables that an exemplary method of completing a form uses in accordance with one embodiment of the systems and methods described herein. The following discusses the method 600 of FIG. 6 and references FIG. 7 for illustrative purposes.

At operation 602, the process 600 may identify a data element corresponding to a data field in a form, which needs to be completed. In one embodiment, a data element may be marked as ignored in the data table as the corresponding data field does not need to be completed. In this case, in some embodiments, the method may skip calculating a value for this data element. In some embodiments, a data field may be marked as approved as the user intends that the data element value for the data field should not be updated and thus the data element is locked. In this case, in some embodiments, the method may not calculate or update a value for this data field. The method 600 may further look for notes that are marked by a user as assumptions and store the assumption accordingly. An assumption informs the party to whom the form may be submitted (e.g., filing authorities) on details of the process taken to calculate a data element value. For example, where the requirements for a data field are not clearly defined or ambiguous and subject to interpretation by a user filing out the form, the user may create an assumption. With reference to FIG. 7, under column 714 of the data table 708 Form Definition, the method 600 may store assumptions. In the illustrated example, assumptions “ASM1” and “ASM2” are stored for the data elements with IDs “Element1.ID” and “Element4.ID,” respectively.

At operation 604, the method 600 may process metadata that is stored in the second data table to determine how to calculate a value for the data element. For example, as illustrated in FIG. 7, metadata that is stored for each data element may comprise a calculation for determining a value for the data element. At operation 606, the method 600 may calculate a value for the data element (e.g., according to the determination of operation 604). In one embodiment, the calculation that is stored in the metadata for a data element may comprise an algorithm for calculating a value. Subsequently, the method 600 may store the value calculated according to the metadata stored in the second data table. For example, with reference to FIG. 7, under column 728 of the data table 724 Form Value, the method 600 may store the value that is calculated according to the metadata stored.

At operation 608, the method 600 may validate the calculated value according to a validation rule. For example, as illustrated in FIG. 7, the calculation that is stored for each data element may comprise a validation process. One exemplary rule is the worth of copper traded at the CME, which is the value for the data element 4, should not exceed the worth of cooper traded, which is the value for the data element 3. At operation 614, the method 600 may give a warning upon determining that the calculated value violates the validation rule stored for that data element. In one embodiment, the method 600 may send out emails to report validation errors. In some embodiments, the method 600 may mark fields that have validation errors in a User Interface.

In some cases, a user may override a value calculated for a data element based on a standard or default calculation method, and accordingly, in further embodiments, a method may create an additional data table to store user-defined metadata which may comprise an override calculation. Referring to the illustrated example in FIG. 7, a data table entry of the data table 716 User Calculation stores the user-defined override calculation for a data element, and associates the override calculation and the data element with the user. In one embodiment, during population of a form, the method may check whether there is a user-defined calculation for a data element. Subsequent to determining that a user-defined override calculation exists, the method may perform the user-defined override calculation and store the value determined accordingly. For example, when calculating a value for the data element with ID “Element1.ID” corresponding to the user with ID “USER1.ID” of the data table 708, the method may check the data table 716 User Calculation and confirm that the user with ID “USER1.ID” has an calculation override Calculation Override 1. Rather than performing the calculation according to Calculation 1, as stored in the metadata for the data element with ID “Element1.ID”, the method may override the metadata stored for the data element 1 and calculate a value based on Calculation Override 1 as stored in the data table 716. The method may then store the calculated value in the data table Form Value 724.

With continued reference to FIG. 6, at operation 610, the method stores the calculated value for each data element. In some embodiments, a user may modify a calculated value by entering a user defined value for a data field and the method 600 may store the user entered value for the corresponding data element accordingly in the appropriate data table. The method may further validate a user entered value, for example, whether the user entered value matches the required data type, or whether the user entered value is in the required data range. At operation 612, the method verifies whether a data element is the last data element of the form. In some embodiments, a user may force the method 600 to reprocess metadata to re-complete a form.

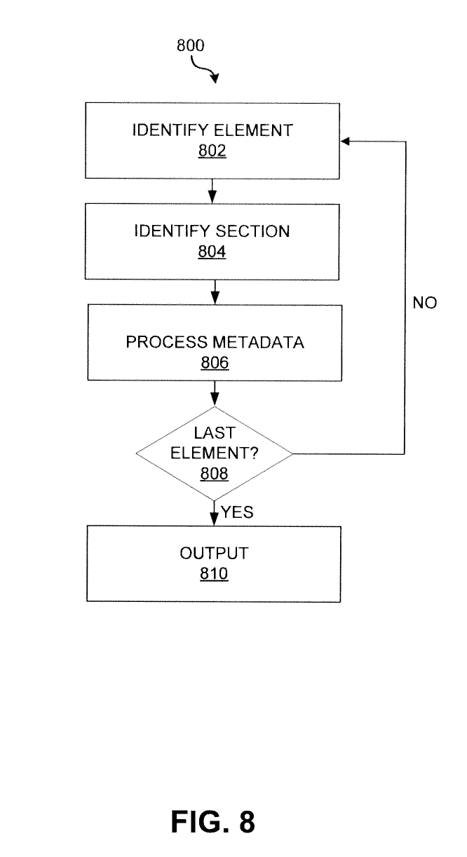

FIG. 8 is a flow chart illustrating an exemplary method 800 of creating an output form in accordance with an embodiment of the systems and methods described herein. An output form may be fully or partially completed according to a user's instruction, and may visually appear the same as the original form. Generally, the output form comprises data elements in the format as required in the original form, and completed with needed values or data.

At operation 802, the method may identify a data element, which corresponds to a data field of the original form. At operation 804, the method 800 may identify the section to which the data element corresponds. The method 800 may associate a data element with a section by referencing to the first data table. At operation 806, the method may process the metadata associated with the data element. In one embodiment, the method 800 may refer to the appropriate data table(s) for the relevant metadata including the description and the visual style. The method 800 may also perform the calculation comprised in the metadata if a value is not stored in the appropriate data table(s). At operation 810, the method 800 may create an output form by associating a data element with the corresponding section, adding the description, applying the visualization style, and inserting the data element value stored. The output form may be presented on the UI or saved in various files formats, including an Excel® spreadsheet, a PDF file or an XML file. In one embodiment, the method 800 may grey out a field that is ignored and ensure that the data field is blank.

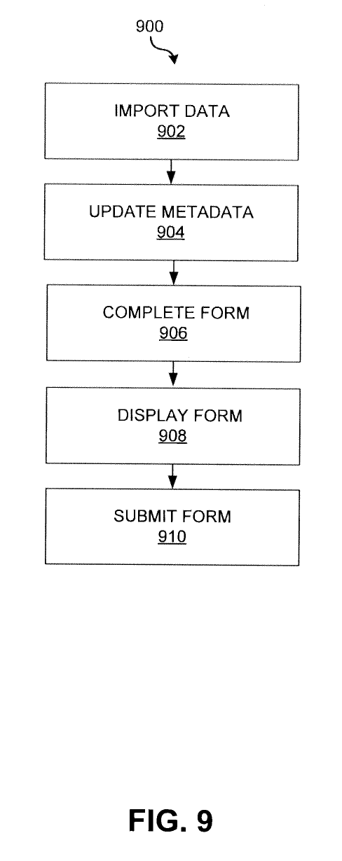

FIG. 9 is a flowchart illustrating an exemplary method 900 of preparing a form in accordance with in accordance with one embodiment of the systems and methods described herein. At operation 902, the method 900 may import data for population of a form from various data sources. In one embodiment, the method 900 may store the data imported in one or more data tables. In various embodiments, the method 900 may allocate and assign attributes related to a form to the data imported. An attribute may be a derivative of a form. Different forms may have different derivatives. A derivative of a form may be related to a data field or a data element. The method may notify a user if an attribute of a form cannot be assigned to any data imported. In further embodiments, the method may generate a list of missing data that is necessary for preparing the form and notify a user accordingly.

At operation 904, the method may update metadata for each data element, which may include a calculation, a validation process, a description of the data element, or a visual style for the data element. At operation 906, the method may complete the form according to a default calculation or a user-defined calculation. The method may select the data necessary for calculating a value for a particular data element based on the assigned attributes that are associated with the form when performing the calculation. In some embodiments, when selecting data, the method may find and aggregate columns of the appropriate data tables storing the data imported according to an aggregation rule. In various embodiments, the method may look for notes that are marked as assumptions, which may be a description of details of the process taken to calculate a data element value, and add to an assumption section in the appropriate data table accordingly.

At operation 908, the method may display a form on a User Interface (UI). In one embodiment, the method 900 may display the completion status of a form. When displaying a form, the method 900 may apply visualization rules according to the metadata stored for each data element. In various embodiments, a user may interact with the form preparation process via the UI. For example, a user may approve or un-approve a value for a data field of a form. When a user approves a value for a data field, the user intends that the value for that data field should not be updated. Once the user approves a value for a data field, the corresponding data element will be marked as approved in the appropriate data table and no further changes can be made to that data element for a given reporting period. Certain users (e.g., users with applicable security rights) may un-approve data fields that have been approved. A user may also ignore or un-ignore a data field of a form. When a user ignores a data field, a value for the data field needs not to be calculated. Once the user ignores a data field, the corresponding data element will be marked as ignored in the appropriate data table for that user and no further changes can be made to that data element for a given reporting period. Certain users (e.g., users with applicable security rights) may un-ignore data fields that have been marked as ignored. Accordingly, the method 900 may update calculations involving those data elements when being marked from ignored to un-ignored or vice versa.

Still referring to FIG. 9, a user may further create note(s) for a data field. The method 900 may associate and store the note(s) with the corresponding data element in the appropriate data table(s). A note may, for example, be an internal note used to track internal discussions that may not affect any calculation. A note may also be an assumption or other data point that may affect a calculation, and may be marked accordingly. An assumption informs the party to whom the form may be submitted (e.g., filing authorities) on details of the process taken to calculate a data element value. For example, where the requirements for a data field are not clearly defined or ambiguous and subject to interpretation by a user filing out the form, the user may create an assumption. In one embodiment, all notes that are added as assumptions may be automatically added to both the notes area and the corresponding columns of the data table(s) where the calculation(s) are stored. Additionally, via a UI, a user may select to view various data, which may include the calculated value, the overridden value, the validation results, the override flag, the grid of data set used for the particular calculation, and/or the assigned attribute(s) for each data element. In one embodiment, the data is SQL data. In one embodiment, the method may generate a data grid and export the data grid into an Excel® spreadsheet.

Further, for any data element, a user may modify the data element value by entering a user defined value. The method 900 may further validate a user entered value, for example, whether the user entered value is in the required data type, whether the user entered value is in the required data range. In various embodiments, the method 900 may create an audit log to record a user's activities, such as, when a user updates a piece of data imported, updates an attribute assignment, and updates a data element value. At operation 910, the method may submit a prepared form according to a user's instruction. In some embodiments, once the preparation is complete and a form is submitted, the method may archive data tables with all the data element values and no further changes are allowed. Archived forms for previous reporting periods may be retrieved at any time.

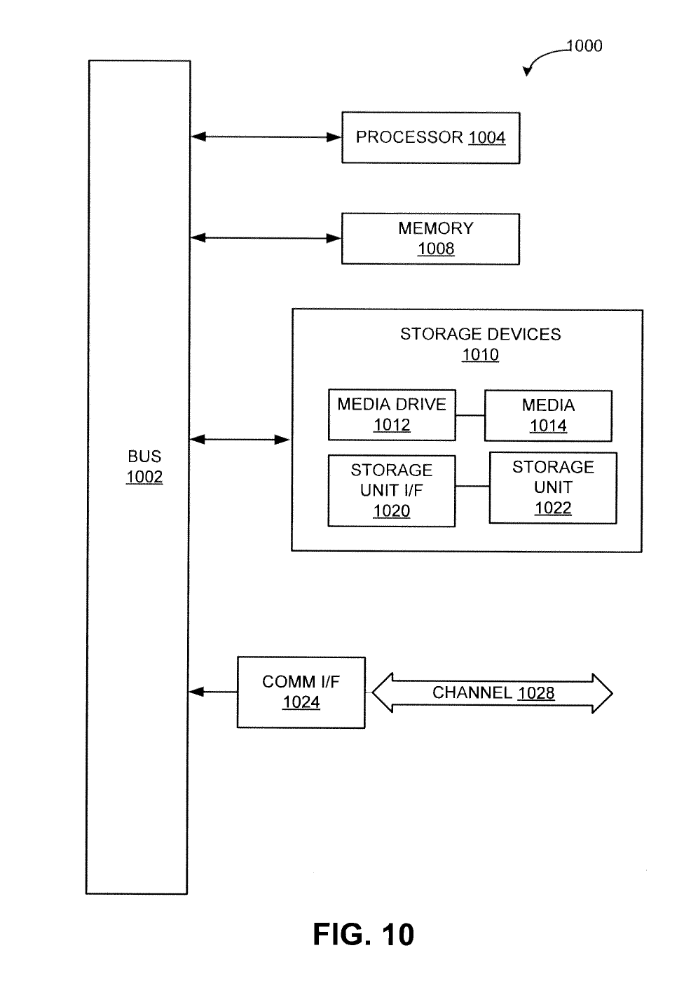

As used herein, the term set may refer to any collection of elements, whether finite or infinite. As used herein, the term module might describe a given unit of functionality that can be performed in accordance with one or more embodiments of the systems and methods described herein. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the systems and methods described hereinare implemented in whole or in part using software, in one embodiment, these software elements can be implemented to operate with a computing or processing module capable of carrying out the functionality described with respect thereto. One such example computing module is shown in FIG. 10. Various embodiments are described in terms of this example-computing module 1000. After reading this description, it will become apparent to a person skilled in the relevant art how to implement the systems and methods described herein using other computing modules or architectures.

Referring now to FIG. 10, computing module 1000 may represent, for example, computing or processing capabilities found within desktop, laptop and notebook computers; hand-held computing devices (PDA's, smart phones, cell phones, palmtops, etc.); mainframes, supercomputers, workstations or servers; or any other type of special-purpose or general-purpose computing devices as may be desirable or appropriate for a given application or environment. Computing module 1000 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 1000 might include, for example, one or more processors, controllers, control modules, or other processing devices, such as a processor 904. Processor 904 might be implemented using a general-purpose or special-purpose processing engine such as, for example, a microprocessor, controller, or other control logic. In the illustrated example, processor 1004 is connected to a bus 1002, although any communication medium can be used to facilitate interaction with other components of computing module 1000 or to communicate externally.

Computing module 1000 might also include one or more memory modules, simply referred to herein as main memory 1008. For example, preferably random access memory (RAM) or other dynamic memory, might be used for storing information and instructions to be executed by processor 1004. Main memory 1008 might also be used for storing temporary variables or other intermediate information during execution of instructions to be executed by processor 1004. Computing module 1000 might likewise include a read only memory (“ROM”) or other static storage device coupled to bus 1002 for storing static information and instructions for processor 1004.

The computing module 1000 might also include one or more various forms of information storage mechanism 1010, which might include, for example, a media drive 1012 and a storage unit interface 1020. The media drive 1012 might include a drive or other mechanism to support fixed or removable storage media 1014. For example, a hard disk drive, a floppy disk drive, a magnetic tape drive, an optical disk drive, a CD or DVD drive (R or RW), or other removable or fixed media drive might be provided. Accordingly, storage media 1014 might include, for example, a hard disk, a floppy disk, magnetic tape, cartridge, optical disk, a CD or DVD, or other fixed or removable medium that is read by, written to or accessed by media drive 1012. As these examples illustrate, the storage media 1014 can include a computer usable storage medium having stored therein computer software or data.

In alternative embodiments, information storage mechanism 1010 might include other similar instrumentalities for allowing computer programs or other instructions or data to be loaded into computing module 1000. Such instrumentalities might include, for example, a fixed or removable storage unit 1022 and an interface 1020. Examples of such storage units 1022 and interfaces 1020 can include a program cartridge and cartridge interface, a removable memory (for example, a flash memory or other removable memory module) and memory slot, a PCMCIA slot and card, and other fixed or removable storage units 1022 and interfaces 1020 that allow software and data to be transferred from the storage unit 1022 to computing module 1000.

Computing module 1000 might also include a communications interface 1024. Communications interface 1024 might be used to allow software and data to be transferred between computing module 1000 and external devices. Examples of communications interface 1024 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 1024 might typically be carried on signals, which can be electronic, electromagnetic (which includes optical) or other signals capable of being exchanged by a given communications interface 1024. These signals might be provided to communications interface 1024 via a channel 1028. This channel 1028 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to media such as, for example, memory 1008, storage unit 1020, media 1014, and channel 1028. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 1000 to perform features or functions of the systems and methods described herein.

While various embodiments of the systems and methods described herein have been described above, it should be understood that they have been presented by way of example only, and not of limitation. Likewise, the various diagrams may depict an example architectural or other configuration for the systems and methods described herein, which is done to aid in understanding the features and functionality that can be included in the systems and methods described herein. The systems and methods described herein are not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the systems and methods described herein. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the systems and methods described herein are done so in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the systems and methods described herein, whether or not such embodiments are described and whether or not such features are presented as being a part of a described embodiment. Thus, the breadth and scope of the systems and methods described herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method for storing and validating forms comprising:
receiving, at a computer system, a form comprising a hierarchy of sections, a section of the hierarchy of sections comprising a set of data elements, and a data element of the set of data elements comprising a data element value and data element metadata;
storing a first data table entry in a first data table corresponding to the data element, the first data table entry comprising a section identification (ID) identifying the section and associating the data element with the section; and
storing a second data table entry in a second data table corresponding to the data element, the second data table entry comprising the data element metadata and a link to the first data table entry.

2. The method of claim 1, further comprising storing a third data table entry in a third data table corresponding to the data element, wherein the third data table entry comprises the data element value and a second link to the first data table entry.

3. The method of claim 1, wherein the first data table entry comprises a data element identification (ID) identifying the data element in the first data table.

4. The method of claim 3, wherein the link to the first data table entry comprises the data element ID.

5. The method of claim 1, wherein the form comprises a second section being a subsection of the first section.

6. The method of claim 1, further comprising determining the data element value for the data element.

7. The method of claim 6, wherein determining the data element value comprises:
receiving a set of data records; and
assigning a set of attributes associated with the form to the set of data records.

8. The computer-implemented method of claim 1, further comprising storing a third data table entry in a third data table corresponding to the data element, the third data table entry comprising a metadata override and a second link to the second data table entry, wherein the metadata override is configured to override at least a portion of the data element metadata.

9. The computer-implemented method of claim 1, further comprising generating a visual output of the data element based on the first data entry and the second data entry.

10. The computer-implemented method of claim 9, wherein the visual output of the data element is generated according to the data element metadata.

11. The computer-implemented method of claim 1, wherein the data element metadata comprises a data element description, a visual style for the data element, or an algorithm associated with the data element value.

12. The computer-implemented method of claim 11, wherein the algorithm comprises a calculation for the data element value or a validation process for the data element value.

13. A form storage and validation system comprising:
a processor configured to receive a form comprising a hierarchy of sections, a section of the hierarchy of sections comprising a set of data elements, and a data element of the set of data elements comprising a data element value and data element metadata; and
a form store comprising a first data table and a second data table, wherein
the first data table stores a first data table entry corresponding to the data element, the first data table entry comprising a section identification (ID) identifying the section and associating the data element with the section, and
the second data table stores a second data table entry corresponding to the data element, the second data table entry comprising the data element metadata and a link to the first data table entry.

14. The form storage and validation system of claim 13, wherein the form store further comprises a third data table, wherein the third data table stores a third data table entry corresponding to the data element, the third data table entry comprising the data element value and a second link to the first data table entry.

15. The form storage and validation system of claim 13, wherein the first data table entry comprises a data element identification (ID) identifying the data element in the first data table.

16. The form storage and validation system of claim 15, wherein the link to the first data table entry comprises the data element ID.

17. The form storage and validation system of claim 13, wherein the data form comprises a second section being a subsection of the first section.

18. The form storage and validation system of claim 13, wherein the processor is further configured to determine the data element value.

19. The form storage and validation system of claim 18, wherein to determine the data element value for the data element, the processor is further configured to:
receive a set of data records; and
assign a set of attributes associated with the form to the set of data records.

20. The form storage and validation system of claim 13, wherein the data form store further comprises a third data table, wherein the third data table stores a third data table entry corresponding to the data element, the third data table entry comprising a metadata override and a second link to the second data table entry, wherein the metadata override is configured to override at least some of the data element metadata.

21. The form storage and validation system of claim 13, wherein the processor is further configured to generate a visual output of the data element based on the first data entry and the second data entry.

22. The form storage and validation system of claim 21, wherein the processor is configured to generate the visual output of the data element according to the data element metadata.

23. The form storage and validation system of claim 13, wherein the data element metadata comprises a data element description, a visual style for the data element, or an algorithm associated with the data element value.

24. The form storage and validation system of claim 13, wherein the algorithm comprises a calculation for the data element value or a validation process for the data element value.

25. A non-transitory computer readable medium comprising executable instructions, the instructions executable by a processor to perform a method, the method comprising:
receiving, at a computer system, a data form comprising a hierarchy of sections, a section of the hierarchy of sections comprising a set of data elements, and a data element of the set of data elements comprising a data element value and data element metadata;
storing a first data table entry in a first data table corresponding to the data element, the first data table entry comprising a section identification (ID) identifying the section and associating the data element with the section; and
storing a second data table entry in a second data table corresponding to the data element, the second data table entry comprising the data element metadata and a link to the first data table entry.
